(19) United States
(12) Patent Application Publication
(10) Pub. No.: US 2014/0317690 A1
(43) Pub. Date: Oct. 23, 2014

(54) Method and System for Allowing Access to a Protected Part of a Web Application

(71) Applicants: Hendrik Gijzen, Heerenveen (NL); Kees Rudolf de Vink, Maastricht (NL)

(72) Inventors: Hendrik Gijzen, Heerenveen (NL); Kees Rudolf de Vink, Maastricht (NL)

(73) Assignee: TELE-ID.NL B.V., Heerenveen (NL)

(21) Appl. No.: 14/115,954

(22) PCT Filed: May 7, 2012
(86) PCT No.: PCT/NL2012/050311

§ 371 Date: Jan. 31, 2014

(30) Foreign Application Priority Data
May 6, 2011 (NL) 2006733

(51) Int. Cl. H04L 29/06

(52) U.S. Cl. CPC H04L 63/10
USPC 726/4

(57) ABSTRACT

The present invention relates to a system and method for allowing access to a protected part of a web application, comprising providing a data carrier with a unique stored carrier-ID and a stored personal property, providing a reader for the data carrier and a reader for reading a personal property, visiting a web application, the web application which can be identified by a web application-ID, issuing a session-ID for the visit, reading the personal property by means of the reader, comparing the read personal property with the stored personal property, sending the combination of the session-ID and the web application-ID to the validating authority when the personal properties match, sending an access permission notification back to the web application by the validating authority when the session-ID and web application-ID properties match and allowing access to the protected part of the website based on the access permission notification.

The present invention provides a method and system for allowing access to a protected part of a web application. This application claims priority from the Dutch application NL 2006733 which is herewith incorporated by reference.

Methods and systems for this purpose are well known in the art. They usually require to enter a username to identify the users and a password to authenticate. If an entered combination of a username and password matches a registered combination of the username and password, access to the web application is allowed.

In certain cases, a username and a password is not considered secure enough, since these can be stolen, guessed or transferred on purpose. Then, additional checks may be performed. An extra question may be asked, or a personal property, determined for example by a fingerprint or iris-scan may be performed, and sent along with the username or username and password, in order to match these with pre-stored details. Although the level of authentication increases with these methods, there is still a risk of fraud, since the details can be intercepted along with the images when they are sent or shared by other media, e.g. voice or email.

The goal of the present invention is to propose a method and system that overcomes the above disadvantages.

The invention thereto proposes a method for allowing access to a protected part of a web application, comprising providing a data carrier with a unique stored carrier-ID, a stored personal property, such as a biometric property, further providing a reader for the data carrier, and a reader for reading a personal property, the method comprising the steps of: upon visiting a web application, which can be identified by a web application-ID, reading the personal property by means of the reader, comparing the read personal property with the stored personal property on the carrier data, sending the combination of the carrier-ID and the web application-ID to a validating authority, looking up the access requirements of the website corresponding to the website ID at the validating authority; looking up personal details, such as an age, of the person corresponding to the carrier ID at the validating authority; when the personal details meet the access requirements, sending an access permission notification back to the web application by the validating authority, and permitting access to the protected part of the website based on the access permission notification.

The invention provides several advantages. Since the personal property, such as a fingerprint or an iris-scan or sort-like biometric is stored on the data carrier, and is read by the reader, there is no direct need to send it over a, secure or insecure, connection, such as the internet, to a web site or a web server. Moreover, the user does not need to enter a username and/or password, since this is provided directly from the validating authority to the web site. Herewith a further reduction of the risk of interception of data is achieved. Furthermore, no personal details, such as a persons age, need to be transferred, since the complete authorisation can take place at the authorisation instance. The data carrier may be any means enabled to store electronic data representing a personal property. The carrier-ID may be regarded as an identifier for the data carrier, and it may have a fixed value. The validating authority may be a webserver, comprising a (central) database or coupled thereto, for storing combinations of carrier-ID's, and personal properties of the holder of the carrier. The carrier ID is not directly linked to access to a website, but the owner In this case, it is easier to arrange replacement of a stolen or damaged card: the user obtains a new card and keeps his access codes. These combinations may be registered once upfront, when a user registers at the website.

The carrier may for instance be a chip-card, wherein the chip comprises an application for comparing a biometric property input with the stored biometric property, and returning a notification indicating wheter there is a match or not. Communication with the card may take place via a card reader, or wireless, for instance because the card is configured with Bluetooth or NFC communication means. The biometric property may be read with a dedicated reader connected to a computer with which a person wants to access a website, or for example with a mobile phone equipped with a reader for biometric properties.

In order to further increase the security, the data carrier may comprise a key and the method further comprises only sending the access code by the validating authority when a verification value, that is encrypted based on the key, matches a predetermined value by the validating authority. This predetermined value may for instance be calculated when the validating authority comprises the same encryption key, coupled to the key (from the data carrier), and the validating authority calculates the same encryption. A Challenge-Response-process is used here that calculates individual responses for all cards present in the database, based on a generated random value, called challenge, per time-slot. When a request is made to log onto a website, a so called challenge is sent to the card and encrypted with the key. A response to the challenge is then returned to the validating authority, which verifies if it matches a stored precalculated response. Then the carrier-ID is determined and the corresponding user is identified.

In a further embodiment, the method comprises repeatedly determining during a time-interval if a verification value that is encrypted based on the key on the data carrier matches a predetermined value by the validating authority. The interval may for example comprise a few seconds, and the check is performed about every second. This way, the chance that a correct response on the verification value is guessed is further eliminated.

A response is valid for a limited amount of time only. When sending the challenge to receive a response, it is known for which timeslot it is valid. Upon receiving the response, it is looked up in a list of precalculated responses for the specific timeslot. The response for a specific timeslot will only remain valid during the timeslot for which one or more challenges are requested or after a configurable period (e.g. 60 seconds).

In an additional embodiment, the data carrier is embodied as a card, such as a card with a credit-card format, so that it can easily be stored in a users wallet and be taken along. The data carrier can also be part of a secure element/secure component e.g. imbedded in a tablet or smartphone.

Although optical and magnetic data storage on such a card may be thinkable, a chip card with electronic memory with a secure element on it is preferred. Such chip card may be provided with active components, such as a data processor. The method according to the invention may comprise providing such a processor on the data carrier, in particular integrated in the chip.

In such an embodiment, the data stored on the data carrier, i.e. in particular the carrier-ID, the personal property and if present the key can be non-readable from the outside, neither optically, nor electronically. Communication with the data carrier may then only be performed via the chip, and the processor. The method may then comprise to perform the comparison of the stored personal property with the read personal property by the processor. The processor may even be configured to initiate this process. This way, the only information that is disclosed by the data carrier is proof that the personal property on the carrier and the personal property read by the reader match (so the personal property stored on the card is not disclosed), and the encrypted verification value, which is returned after receiving one or more verification values within a time interval. The processor on the data carrier may thereto be configured for comparing a stored personal property with a measured personal property and encrypting a verification value and returning the encrypted value.

The data carrier needs to be placed in a reader. In case of a chip-card, this chip-card-reader may be coupled to a computer, for example a computer that is used to browse to the website. This can be a desktop computer, but also a laptop or a handheld device. The device may be coupled with a reader for reading the personal property. This can for example be a fingerprint-reader or scanner, or a iris-scanner or reader, or a photographic face recognition device for example.

The validating authority may be formed by a webserver, in particular a webserver from an authorised organisation. This may also be an organisation that issues the data carriers. When the card is issued to a user, loading a personal property, generating and storing the carrier-ID and the carrier key needs to be performed. Storage of carrier-ID and carrier key will be on the carrier as well as on the server of the issuing organization. Upon issuing the card, details, for unique identification of the person, that is to receive the card are stored at the validating authority. The validating authority comprises an overview of which card is issued to which user. This link is kept secret and it not sent over the internet during an authorisation process.

Preferentially, according to the present invention, all data is sent in an encrypted form.

The invention will now be elucidated into more detail with reference to the following figures. Herein:

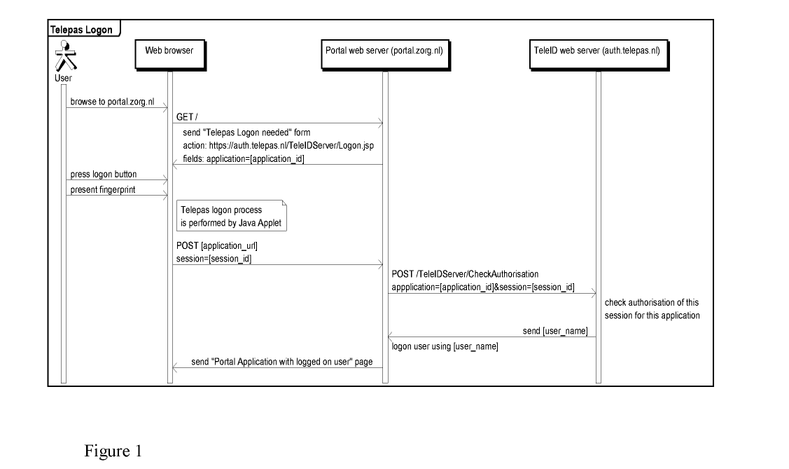

FIG. 1 shows a schematic overview of a protocol for use in the invention;

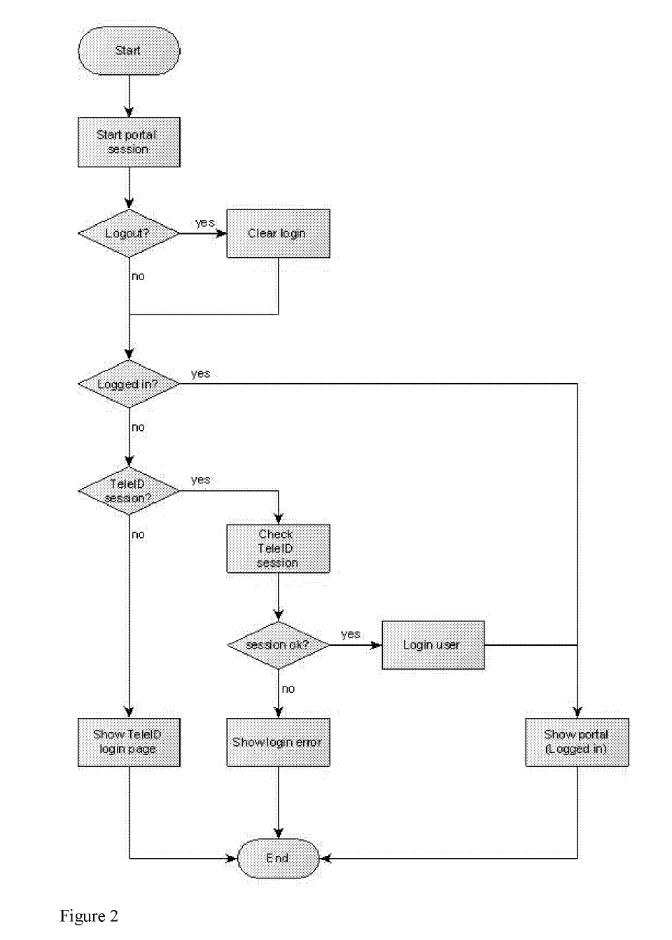

FIG. 2 shows a flowchart of logging onto the website.

FIG. 1 shows a schematic overview of a protocol for use in the present invention. A user wants to log on to a website, here referred to as “the portal”. Initially, the user is not yet logged on to the portal. The portal shows a page that indicates that a logon is required. A user may then choose to use a secured logon according to the present invention, which is offered amongst other possibilities. The method according to the invention is referred to as “Telepas login” in the figure. A web form is sent to the client (a computer or mobile device on which the user wants to enter the website). When the user chooses to log on with the Telepas login he is redirected to the validating authority, here referred to as “TeleID web server”. An authorisation process is performed with the data carrier, here referred to as “Telepas” at the TeleID web server. The authorisation process comprises the steps of reading the personal property by means of the reader, comparing the read personal property with the stored personal property, authenticating the carrier, the sending of the combination of the the key and the website ID to the TeleID web server when the personal properties match, sending an access code, here referred to as a login name, back to the website by the validating authority when the combination of the key and the website ID is recognised and the check of the credentials of the user in combination with the web applicationID is positive. If the combination is not recognised, no access code is returned, and no access is provided to the website.

FIG. 2 shows a flow chart of a logon procedure according to the present invention.

Beside the example given, various embodiments are thinkable, which are all considered to fall within the scope of the present invention as described in the following claims.

1. A method for allowing access to a protected part of a web application, comprising:
providing a data carrier with
a unique stored carrier-ID,
a stored personal property, such as a biometric property, providing
a reader for the data carrier, and
a reader for reading a personal property, such as a biometric sensor, the method comprising the steps of:
upon visiting a web application, which can be identified by a web application-ID, reading the personal property by means of the reader,
comparing the read personal property with the stored personal property on the carrier data,
sending the combination of the carrier-and the web application-ID to a validating authority,
looking up the access requirements of the website corresponding to the website ID at the validating authority;
looking up credentials e.g. age, of the person corresponding to the carrier ID at the validating authority;
when the credentials meet the access requirements, sending an access permission notification back to the web application by the validating authority, and
permitting access to the protected part of the website based on the access permission notification.

2. The method according to claim 1, further comprising the step of: before sending an access permission notification back to the web-site, verifying at the validating authority if the person corresponding to the carrier ID is allowed to visit the website with the website ID.

3. The method according to claim 1, wherein the step of comparing the read personal property with the stored personal property is performed by a chip on the carrier.

4. The method according to claim 1, wherein the data carrier comprises a non-externally-readable key, and the method comprises:
only sending the access permission notification by the validating authority when a verification value that is secured based on the key on the data carrier matches a predetermined value by the validating authority.

5. The method according to claim 4, comprising repeatedly determining during a time-interval if a verification value that is encrypted based on the key on the data carrier matches a predetermined value by the validating authority.

6. The method according to claim 1, comprising providing a card as a data carrier.

7. The method according to claim 6, comprising providing a processor on the data carrier, in particular integrated on a chip.

8. The method according to claim 7, comprising comparing the stored personal property and the read personal property by the processor.

9. A data carrier for use in accessing a web application, comprising:
a memory, configured for storing in a non-externally-readable manner:
a carrier-ID;
a personal property;
a key; and
a processor, configured for:
comparing a stored personal property with a measured personal property; and generation of and returning a verification value.

10. A system for performing a method of accessing a web application, comprising:
a data carrier according to claim 9; and
a validating authority, configured for:
receiving the combination of the carrier-ID and the web application-ID; and
returning an access permission notification to the website when the combination of the carrier-ID- and the web application-ID is recognised.

11. The system according to claim 10, wherein the validating authority comprises a webserver with a database coupled thereto.

12. The system according to claim 11, comprising a website, configured for:
allowing access to the protected part of the web application, based on the access code.
